(19) United States
(12) Patent Application Publication
(10) Pub. No.: US 2009/0089667 A1
(43) Pub. Date: Apr. 2, 2009

(54) Application Content Format Based on Display Resolution

(75) Inventors: Catherine Wood, Chicago, IL (US); Srinidhi Subbarao, Rolling Meadows, IL (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/864,553

(22) Filed: Sep. 28, 2007

(51) Int. Cl. G06F 15/00

(52) U.S. Cl. 715/273

(57) ABSTRACT

An apparatus includes an interface to receive a first indicator representative of a display resolution of a display device and a second indicator representative of an application content file and an application content store configured to select the application content file from a plurality of application content files based on the second indicator. The apparatus further includes an application style store configured to select an application style file from a plurality of application style files based on the first indicator, an interpreter application configured to generate a visual representation of an application using the application content file and the application style file, the visual representation being formatted for the display resolution of the display device. The application further includes an interface to provide the visual representation of the application for display at the display device.

### FIELD OF THE DISCLOSURE

The present disclosure generally relates to communications networks, and more particularly relates to formatting visual content associated with applications utilizing communications networks.

### BACKGROUND

The visual appearance of an application is affected by the display characteristics of the display on which it is viewed. An application that has a suitable appearance on, for example, a high-definition (HD) television often can have a deteriorated appearance on a standard definition (SD) television due to their differences in resolution and aspect ratios. Likewise, an application that is suitable for display on a television often may have a significantly altered appearance on a computer monitor or a cell phone, and vice versa. In an effort to accommodate different display types, application providers conventionally have developed a separate version of the application for each type of display. To illustrate, for a hypertext markup language (HTML)-based application for viewing on a television, an application provider typically develops separate HTML documents, each with embedded formatting information for a corresponding display format, such as the standard definition (SD) format, the SD-wide format, and the HD format. However, the development of separate application versions for each type of viewing environment expected to be encountered results in unnecessary effort and delay in development and testing time as each application version is independently developed and tested. Accordingly, an improved technique for providing an application for display in different viewing environments would be advantageous.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network in accordance with one embodiment of the present disclosure;

FIG. 2 is a block diagram illustrating a server-based application content formatting system in accordance with at least one embodiment of the present disclosure;

FIG. 3 is a flow diagram illustrating a server-based application content formatting technique in accordance with at least one embodiment of the present disclosure;

FIG. 4 is a block diagram illustrating a local application content formatting system in accordance with at least one embodiment of the present disclosure; and

FIG. 5 is a flow diagram illustrating a local application content formatting technique in accordance with at least one embodiment of the present disclosure.

FIG. 6 is a diagram illustrating an example computer system for implementing one or more of the techniques described herein in accordance with at least one embodiment of the present disclosure.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

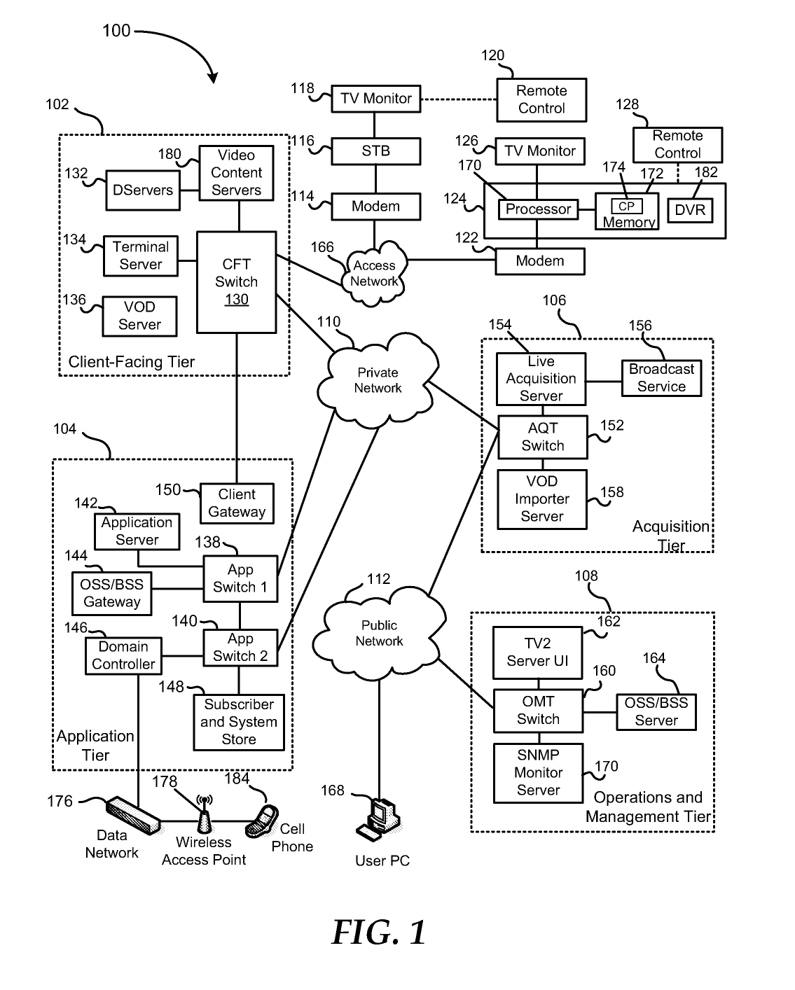

FIGS. 1-6 illustrate example techniques for providing an application that is formatted for a particular viewing environment. In one embodiment, the content of the application is provided in an application content file and display formatting information for the content of the application for each expected viewing environment is stored in a separate corresponding application style. At least one display characteristic (e.g., an aspect ratio or a display resolution) of the display device on which the application is to be displayed is used to select a particular application style file from a plurality of application style files associated with the application content file. The display formatting information of the selected application style file is used to visually format the content of the application specifically for the display characteristics of the display device. By using the same application content file for different viewing environments while customizing the content for a particular viewing environment using a application style file corresponding to a particular viewing environment, development and testing efforts for an application can be reduced compared to conventional techniques.

The term “file,” as used herein, refers to a set of one or more files or other logical data organization or structure. The term “application content file,” as used herein, refers to a file that stores information regarding the content of a corresponding application. Examples of application content include text, buttons or other user interactive features, graphical elements (or links thereto) such as images, tables, dividers, borders, and the like. The term “application style file,” as used herein, refers to a file that stores information regarding a visual formatting of some or all of the elements of a corresponding application content file. Examples of visual formatting include font size, font color, font type, graphical element size, graphical element placement, and the like.

For ease of illustration, the example techniques disclosed herein are described in the context of markup language-based application content files (e.g., hypertext markup language (HTML)-based files) and cascading style sheet (CSS)-based application style files. Other implementations of application content files and application style files may be implemented using the guidelines provided herein without departing from the scope of the present disclosure. The example techniques disclosed herein also are described in the context of an Internet Protocol Television (IPTV) network utilizing a set-top box to interface between a display device, such as a television or computer, and one or more content servers. However, these techniques also can be implemented in other contexts without departing from the scope of the present disclosure. To illustrate, some or all of the illustrated techniques may be utilized at a cell-phone, personal digital assistant (PDA), or other communications-enabled portable device.

FIG. 1 illustrates an IPTV system 100 in accordance with at least one embodiment of the present disclosure. The IPTV system 100 can include a client facing tier 102, an application tier 104, an acquisition tier 106, and an operations and management tier 108. Each tier 102, 104, 106, and 108 is coupled to a private network 110, a public network 112, or both the private network 110 and the public network 112. For example, the client-facing tier 102 can be coupled to the private network 110. Further, the application tier 104 can be coupled to the private network 110 and to the public network 112, such as the Internet. The acquisition tier 106 can also be coupled to the private network 110 and to the public network 112. Moreover, the operations and management tier 108 can be coupled to the public network 112.

The various tiers 102, 104, 106, and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems, such as a first modem 114 and a second modem 122 can be coupled to the private access network 166. The client-facing tier 102 can communicate with a first representative set-top box device (STB) 116 via the first modem 114 and with a second representative set-top box device 124 via the second modem 122. The client-facing tier 102 can communicate with a large number of set-top boxes, such as the representative set-top boxes 116 and 124, over a wide geographic area, such as a regional area, a metropolitan area, a viewing area, or any other suitable geographic area that can be supported by networking the client-facing tier 102 to numerous set-top box devices. In an illustrative embodiment, the client facing tier or any portion thereof can be included at a video head-end office.

In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received through the private access network 166 via an IPTV software platform such as Microsoft® TV IPTV Edition.

Additionally, the first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display devices 118 and 126 to which it is coupled. In an illustrative embodiment, the set-top box devices 116 and 124 can include tuners that receive and decode television programming information for transmission to the display devices 118 and 126. The television tuner can be National Television System Committee (NTSC) tuner, an Advanced Television System Committee (ATSC), another suitable analog or digital tuner, or any combination thereof. A signal for a television channel can pass through the tuner before the content is displayed on a monitor.

In an exemplary, non-limiting embodiment, STB devices 116 and 124 can receive video content, which may include video and audio portions, from the client-facing tier 102 via the private access network 166. The STB device 116 and 124 can transmit the video content to an external display device, such as the television monitors 118 and 126. The STB devices 116 and 124 can also communicate commands received from the remote control devices 120 and 128 to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides access to terminal devices, such as a game application server 168 and other devices with a common connection point to the private network 110. In a particular embodiment, the CFT switch 130 can also be coupled to a video-on-demand (VOD) server 136 that stores or provides VOD content imported by the IPTV system 100. The client-facing tier 102 can also include one or more video content servers 180 that transmit video content requested by viewers via their STB devices 116 and 124. In an illustrative, non-limiting embodiment, the video content servers 180 can include one or more multicast servers.

As shown in FIG. 1, the application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions, such as display, messaging, processing of IPTV data and VOD material, etc. In a particular embodiment, the OSS/BSS gateway 144 includes operation systems and support (OSS) data, as well as billing systems and support (BSS) data.

Further, the second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166, using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when a set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138 to the second APP switch 140, and the second APP switch 140 can communicate the query across the public network 112 to an OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, for example because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment during operation of the IPTV system, the live acquisition server 154 can acquire television or movie content. The live acquisition server 154 can transmit the television or movie content to the AQT switch 152, and the AQT switch can transmit the television or movie content to the CFT switch 130 via the private network 110.

Further, the television or movie content can be transmitted to the video content servers 180, where it can be encoded, formatted, stored, or otherwise manipulated and prepared for communication to the STB devices 116 and 124. The CFT switch 130 can communicate the television or movie content to the modems 114 and 122 via the private access network 166. The STB devices 116 and 124 can receive the television or movie content via the modems 114 and 122, and can transmit the television or movie content to the television monitors 118 and 126. In an illustrative embodiment, video or audio portions of the television or movie content can be streamed to the STB devices 116 and 124.

Further, the AQT switch can be coupled to a VOD importer server 158 that stores television or movie content received at the acquisition tier 106 and communicates the stored content to the VOD server 136 at the client-facing tier 102 via the private network 110. Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the STB devices 116 and 124, the requests can be transmitted over the private access network 166 to the VOD server 136 via the CFT switch 130. Upon receiving such requests, the VOD server 136 can retrieve the requested VOD content and transmit the content to the STB devices 116 and 124 across the private access network 166 via the CFT switch 130. The STB devices 116 and 124 can transmit the VOD content to the television monitors 118 and 126. In an illustrative embodiment, video or audio portions of VOD content can be streamed to the STB devices 116 and 124.

The operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to the OSS/BSS server 164 and to a simple network management protocol (SNMP) monitor 170 that monitors network devices within or coupled to the IPTV system 100. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 can transmit the television or movie content to the AQT switch 152, and the AQT switch 152 in turn can transmit the television content to the CFT switch 130 via the private network 110 or to the OMT switch 160 via the public network 112. Further, the television content can be encoded at the D-servers 132, and the CFT switch 130 can communicate the television content to the modems 114 and, 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to set-top box devices 116 and 124, the request can be transmitted over the private access network 166 to the VOD server 136 via the CFT switch 130. Upon receiving such a request, the VOD server 136 can retrieve requested VOD content and transmit the content to the set-top box devices 116 and 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer 168 coupled to the private network 110.

The domain controller 146 communicates with the public network 112 via the second APP switch 140. Additionally, the domain controller 146 can communicate via the public network 112 with the personal computer 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices, such as a cellular telephone 184.

In a particular embodiment, a set-top box device such as the second set-top box device 124 can include an STB processor 170 and an STB memory device 172 that is accessible to the STB processor 170. The set-top box device 124 also includes a STB computer program 174 that is embedded within the STB memory device 172. In a particular embodiment, the STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124, by associating the user account with an IP address of the second set-top box device with data relating to one or more twisted pairs connected with the second set-top box device 124, with data related to one or more fiber optic cables connected with the second set-top box device 124, with an alphanumeric identifier of the second set-top box device 124, with any other data that is suitable for associating second set-top box device 124 with a user account, or with any combination of these.

The STB computer program 174 can contain instructions to receive many types of user preferences from the domain controller 146 via the access network 166. For example, the STB computer program 174 can include instructions to receive a request to record at least one television program at a video content storage module such as a digital video recorder (DVR) 182 within the second set-top box device 124. In this example embodiment, the STB computer program 174 can include instructions to transmit the request to the DVR 182, where the television program(s) are recorded. In an illustrative embodiment, the STB computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP). Further details of the IPTV system are taught in U.S. Patent Application Publication No. 2007/0199041, the disclosure of which is hereby incorporated by reference.

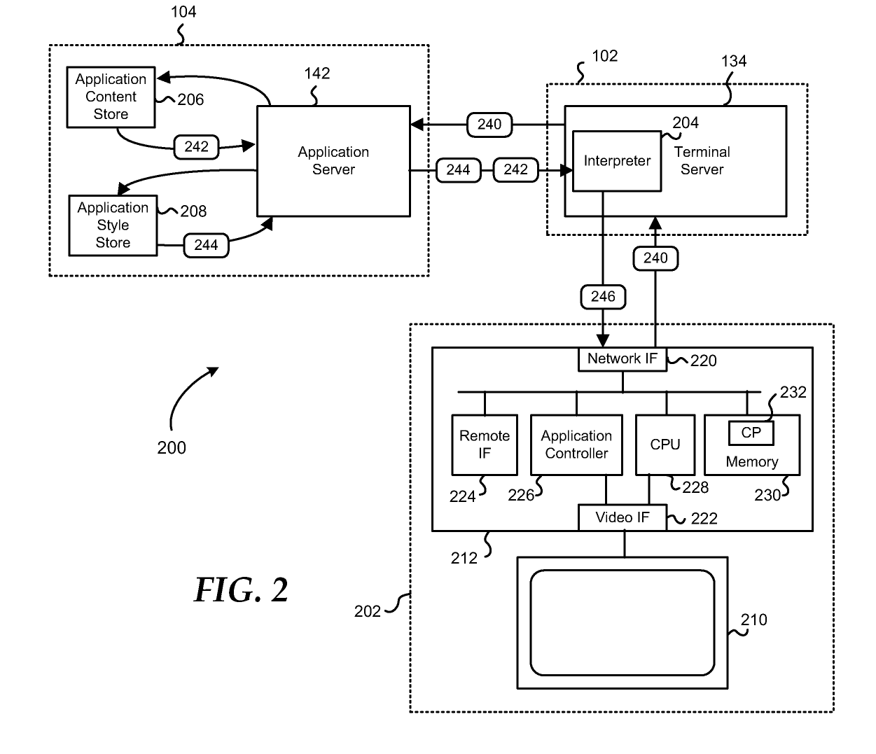

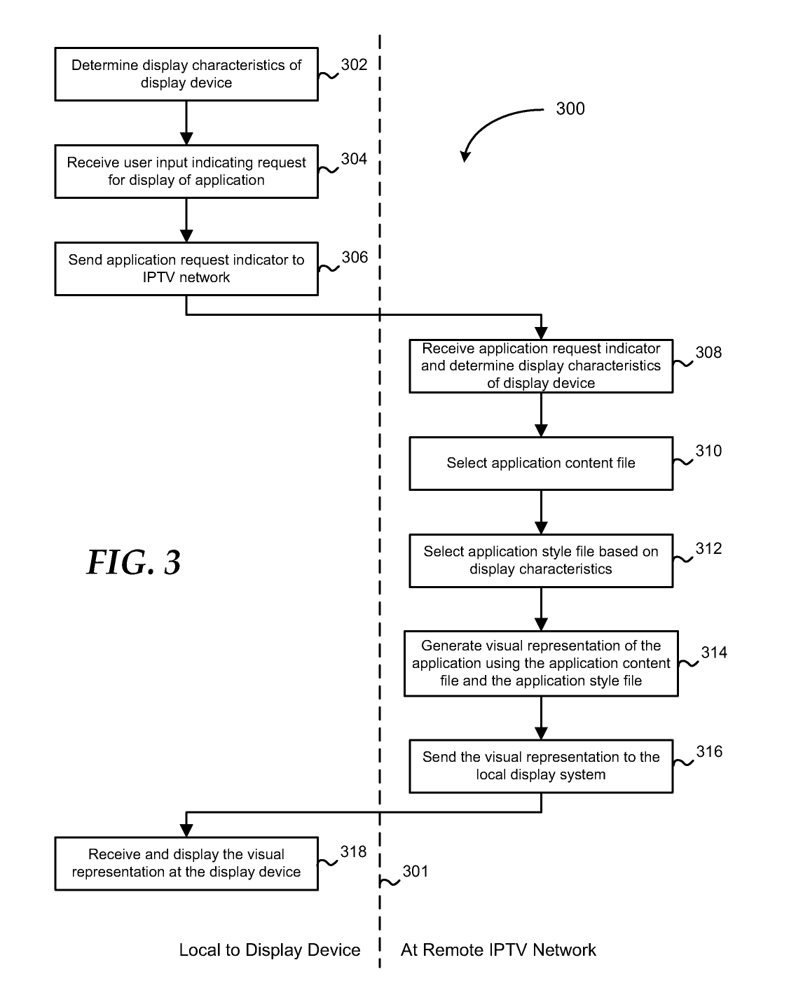

FIGS. 2 and 3 illustrate an example server-based application formatting system 200 and an example method 300 of its operation in accordance with at least one embodiment of the present disclosure. For ease of illustration, the server-based application formatting system 200 is described in the context of the IPTV system 100 of FIG. 1, whereby certain elements of the IPTV system 100 have been omitted for clarity purposes.

The application formatting system 200 includes a local display system 202 connected to the terminal server 134 of the client-facing tier 102 via, for example, the access network 166 (FIG. 1). The terminal server 134, in turn, is connected to the application server 142 of the application tier 104 via, for example, the private network 110 (FIG. 1). In the example of FIG. 2, the client-facing tier 102 includes an interpreter 204 implemented at the terminal server 134 and the application tier 104 includes an application content store 206 and an application style store 208. The application content store 206 includes a database or other storage component configured to store application content files for applications supported by the application server 142. The application style store 208 includes a database or other storage component configured to store a plurality of application style files for each corresponding application content file, each of the plurality of application style files associated with a corresponding viewing environment in which an application is expected to be displayed.

In one embodiment, the application content files stored in the application content store 206 are implemented as markup language-based files, such as HTML files, extensible markup language (XML) files, extensible hypertext markup language (XHTML) files, active server pages (ASP) files, java server pages (JSP) files, image files, video files, and the like. The markup language-based application content files store information regarding the content of the application and its interface, such as text to be displayed, images or other graphical elements to be displayed (or hyperlinks thereto), application routines (e.g., JavaScript applets), application plug-in information (e.g., for video player plug-ins), and the like. Correspondingly, the application style files stored in the application style store 208 are implemented as style sheet files, such as cascading style sheet (CSS) files, JavaScript style sheets (JSSS), and the like. The style sheet-based application style files store information regarding the formatting of the content in the corresponding application content file, such as the styles, sizes, and colors of text to be displayed, the color of backgrounds, the size, borders, and alignment of visual elements, and the like.

Table 1 below illustrates a simple example of an application content file having an HTML format and Tables 2 and 3 illustrate simple examples of CSS-based application style files for the application content file of Table 1, in which Table 2 corresponds to a SD viewing environment, Table 3 corresponds to an HD viewing environment.

TABLE 1
Example HTML-based Application Content File

```
<!DOCTYPE HTML PUBLIC “-//W3C//DTD HTML 4.0
Transitional//EN”>
<html>
<head>
<title></title>
<link rel=“stylesheet” type=“text/css” href=“SD.css” title=“SDStyle” />
<link rel=“alternate stylesheet” type=“text/css” href=“hd.css”
title=“HDStyle” />
<script id=“clientEventHandlersJS” language=“javascript”>
  var qsParams = new Array( );
  qsParams[‘appheight’]=null;
  qsParams[‘appwidth’]=null;
  readQS( );
  function readQS( )
  {
    var query = window.location.search.substring(1);
    var parms = query.split(‘&’);
  for (var i=0; i < parms.length; i++)
  {
        var pos = parms[i].indexOf(‘=’);
      if (pos > 0)
      {
            var key = parms[i].substring(0,pos);
            var val = parms[i].substring(pos+1);
            qsParams[key] = val;
          }
      }
  }
  function setSizeStyle( ) {
    if (qsParams[‘appheight’] == 480){
        setActiveStyleSheet(“SDStyle”);
            } else {
              setActiveStyleSheet(“HDStyle”);
            }
    }
    function setActiveStyleSheet(title) {
    var i, a, main;
    for(i=0; (a = document.getElementsByTagName(“link”)[i]); i++) {
      if(a.getAttribute(“rel”).indexOf(“style”) != −1
        && a.getAttribute(“title”)) {
        a.disabled = true;
        if(a.getAttribute(“title”) == title) a.disabled = false;
      }
    }
}
function init( )
{
      setSizeStyle( );
}
  setSizeStyle( );
  </script>
</head>
<!--
<script language=“javascript”>
document.write(qsParams[‘appheight’]);
document.write(qsParams[‘appwidth’]);
</script>
<h1 style=“font-size:26px; font-weight:bold”>Aspect Ratio coordinated
Font Sizes</h1>
<div id=“textSizer”>
<img src=“fontSizer.jpg” height=“18” width=“72” alt=“Font Sizer”><a
href=“” onclick=“changeSizeStyle(‘smallStyle’); return false”><img
class=“textSize” src=“fontSmall.jpg” height=“18” width=“18”
alt=“Smallest” /></a><a href=“” onclick=“changeSizeStyle(‘’); return
false”><img
class=“textSize” src=“fontMedium.jpg” height=“18” width=“18”
alt=“Default” /></a><a
href=“” onclick=“changeSizeStyle(‘largeStyle’); return false”><img
class=“textSize” src=“fontLarge.jpg” height=“18” width=“18”
alt=“Biggest” /></a>
</div>
<hr />
-->
        <body onload=“init( )”>
            <br />
            <br />
            <p align=“center” style=“FONT-FAMILY:Arial”>
                This is Arial
            </p>
            <p align=“center” style=“FONT-FAMILY:Arial”>
                <b>This is Segoe</b>
            </p>
            <p align=“center” style=“FONT-FAMILY:Times New
            Roman”>
                <b>This is Times New Roman Bold</b>
            </p>
            <p align=“center” style=“FONT-FAMILY:Times New
            Roman”>
                This is Times New Roman
            </p>
            <p align=“center” style=“FONT-FAMILY:Segoe Bold”>
                This is Segoe
            </p>
            <p align=“center” style=“FONT-FAMILY:Segoe
            Semibold”>
                This is Verdana
            </p>
            <p align=“center” style=“FONT-FAMILY:Segoe”>
                This is ONLY Segoe
            </p>
            <p align=“center” style=“FONT-FAMILY:Verdana”>
                This is Verdana
            </p>
            <p style=“FONT-FAMILY: Segoe” align=“center”>
            <INPUT id=“Button1” type=“button” value=“Next-->”
name=“Button1” onclick=“return Button1_onclick( )”></p>
</body>
</html>
```

TABLE 2
Example CSS-based Application Style File for SD Format

p {font-size:20px; filter:alpha(opacity=100)}

TABLE 3
Example CSS-based Application Style File for HD Format

p {font-size:30px}

The example application content file of Table 1 is configured to display various lines of text in different font styles. The function readQS determines the URL parameter (“appheight”) that sets the viewing environment as either SD or HD and the function setSizeStyle selects either the SD application style file (Table 2) or the HD application style file (Table 3) based on the determined viewing environment. As illustrated by Table 2, when the viewing environment is in the SD format, the font size is set to 20 pixels and the alpha blending value for opacity is set to 100. As illustrated by Table 3, when the viewing environment is in the HD format, the font size is set to 30 pixels. Thus, as the simple example of Tables 1-3 illustrates, the same content of the application content file for an application (e.g., lines of text) can be visually formatted specifically for a particular viewing environment (e.g., font size of the lines of text) by using style formatting information in a corresponding application style file.

The local display system 202 includes a display device 210 and a local display device interface 212. In one embodiment, the display device 210 includes a television monitor (e.g., television monitor 126, FIG. 1) or a computer monitor and the local display device interface 212 includes a set-top box (e.g., set top boxes 116 and 124, FIG. 1) configured as an interface between the television monitor/computer monitor and the access network 166 (FIG. 1). The set-top box can be implemented separate from the television monitor or computer monitor, or some or all of the components of the set-top box can be integrated with the television monitor/computer monitor. In an alternate embodiment, the local display system 202 includes a communications-enabled portable device, such as a cell phone. In this instance, the display device 210 can include the display of the portable device and the local display device interface 212 can include internal components of the portable device configured to interface with the access network 166.

In the depicted example, the local display device interface 212 includes a network interface 220, a video interface 222, a remote interface 224, an application controller 226, a central processing unit (CPU) 228, and a computer readable medium, such as a memory 230, a hard drive, flash memory, or a combination thereof. The computer readable medium stores a computer program 232 representing instructions executable by the CPU 228 or other component of the local display device interface 212 that manipulate the CPU 228 or other component to perform the functionality described herein.

The network interface 220 is configured to interface with the access network 166 for communications with the client-facing tier 102 and therefore includes an interface compatible with the network type of the access network 166. The remote interface 224 includes an infrared interface or radio frequency (RF) interface for receiving command signals from a remote control or a button panel of the display device 210. The video interface 222 is configured to interface with, and control the operation of, the display device 210. To illustrate, the video interface 222 can include an high-definition multimedia interface (HDMI), a digital video interface (DVI), a National Television Standards Committee (NTSC)-based coaxial cable interface, an S-video interface, and the like.

The application controller 226, in one embodiment, is configured to manage the provision of application content to a viewer via the display device 210. In response to user input via the remote interface 224 indicating a selection of an application for display, the application controller 226 interacts with the client-facing tier 102 to obtain data representing a visual interface to the application, formats the data as appropriate, and provides the formatted data to the video interface 222 for display at the display device 210. The application controller 226 can be implemented as hardware, software (e.g., as part of computer program 232), firmware, or a combination thereof.

In one embodiment, the local display device interface 212 and the terminal server 134 are configured to interact in a terminal services mode whereby the local display device interface 212 accesses applications via the terminal server 134 using a terminal services protocol, such as the Microsoft™ Remote Desktop Protocol (RDP). Accordingly, the terminal server 134 accesses application data from the application server 142 and utilizes the interpreter 204 to generate a visual representation of the application data. The visual representation then can be transmitted to the local display device interface 212 for formatting and display. To illustrate, for markup-language based application interfaces, the interpreter 204 can include a markup-language interpreter configured to interpret markup language-based files to generate a visual representation of the content of the files. An example of a markup language-based interpreter includes a web browser, such as the Microsoft™ Internet Explorer web browser, the Mozilla Firefox web browser, the Opera web browser, the Lynx web browser, and the like. Alternately, a proprietary interpreter may be implemented instead of a commercially-available solution.

FIG. 3 illustrates a method 300 of an example operation of the server-based application formatting system 200 of FIG. 2 in accordance with at least one embodiment of the present disclosure. In the depicted example, processes represented by blocks to the left of dividing line 301 are performed at the local display system 202, whereas processes represented by blocks to the right of the dividing line 301 are performed remotely at a content server (such as the client-facing tier 102 and the application tier 104 of the IPTV network 100).

At block 302 the local display device interface 212 determines one or more display characteristics of the display device 210. The display characteristics can include, for example, the aspect ratio of the display device (e.g., 4:3 for an SD format or 16:9 for an SD-wide format and an HD format), the resolution of the display device, and the like. The local display device interface 212 can determine the one or more display characteristics in any of a variety of ways. For an Extended Display Identification Data (EDID)-enabled display device, the local display device interface 212 can use an EDID interface to access the EDID information of the display device 210 to determine the one or more display characteristics. Alternately, the local display device interface 212 can be preprogrammed with the display characteristics of the display device 210, or the user can enter the display characteristics during a setup configuration.

At block 304, the local display device interface 212 receives user input indicating the user has selected a particular application for display. In one embodiment, the user input is represented by a remote control command received via the remote interface 224 and provided to the application controller 226 for processing. Alternately, the user input can be received via, for example, a keyboard, a button panel, or the like.

In response to receiving the user input, the application controller 226 generates an application request indicator 240 and sends the application request indicator 240 to the client-facing tier 104 at block 306. The application request indicator 240, in one embodiment, includes an indicator of the application to be provided and an indicator of one or more of the display characteristics determined at block 302. In web-based implementations, the application request indicator 240 can include a uniform resource locator (URL) associated with the requested application, and whereby the indicator of the display characteristic can be provided as a parameter in the URL. For example, to request an application associated with the URL <<http://www.application.com>> for display at a HD display device with a resolution of 1920×1080, the application controller 226 can provide the URL <<http://www.application.com?appwith=1920>> or http://www.application.com?aspectratio=HD> so as to identify the application using the URL portion “http://www.application.com” and to identify the display characteristic using the URL parameter “appwith=1920” or the URL parameter “aspectratio=HD”. Alternately, the application request indicator 240 can be transmitted as information in one or more packets, whereby a header or other field of the packet identifies the corresponding display characteristic.

At block 308, the client-facing tier 102 receives the application request indicator 240 and forwards it to the application server 142. Using the application request indicator 240, the application server 142 identifies the requested application and identifies the indicated display characteristic. At block 310, the application server 142 accesses the application content file 242 that corresponds to the identified application from the application content store 206. In at least one embodiment, for a given application content file, the application style store 208 includes a number of different application style files, each corresponding to a different display characteristic. Accordingly, at block 312 the application server 142 accesses from the application style store 208 an application style file 244 selected from the plurality of application style files based on the identified display characteristic. The application server 142 then provides the application content file 242 and the application style file 244 to the terminal server 134.

At block 314 the interpreter 204 uses the visual formatting information of the application style file 244 to format the content of the application content file 242 for the generation of a visual representation 246 of the application. At block 316, the terminal server 134 sends data corresponding to the visual representation 246 to the local display system 202 using a terminal server protocol, such as the RDP protocol. At block 318, the visual representation 246 is received and processed by the local display device interface 212 and provided for display at the display device 210.

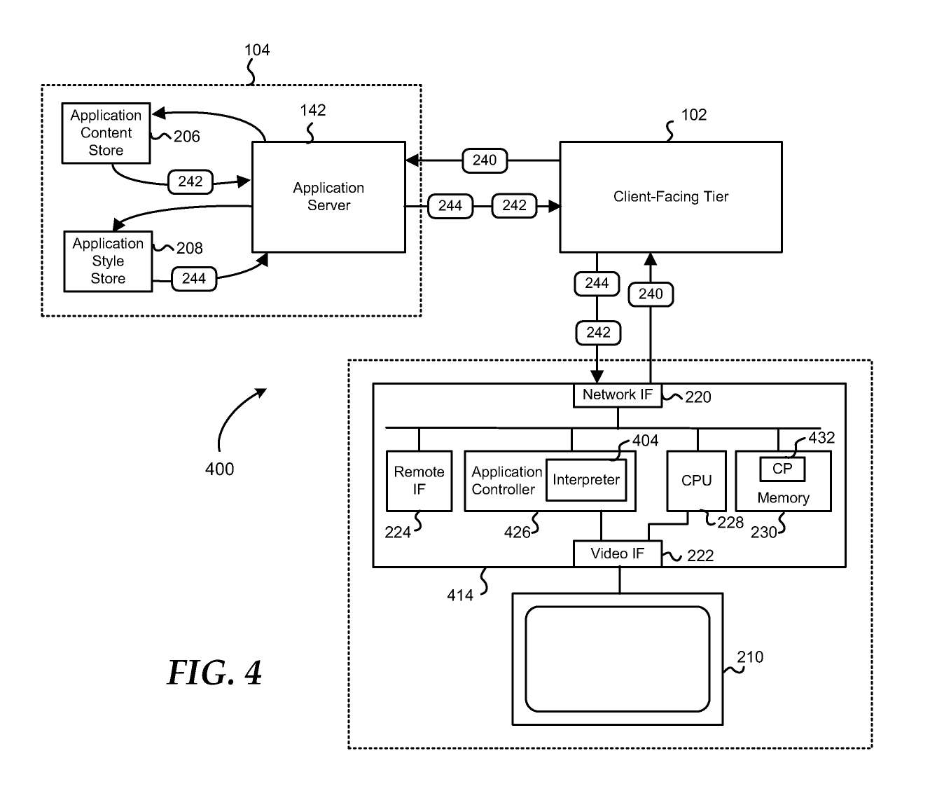

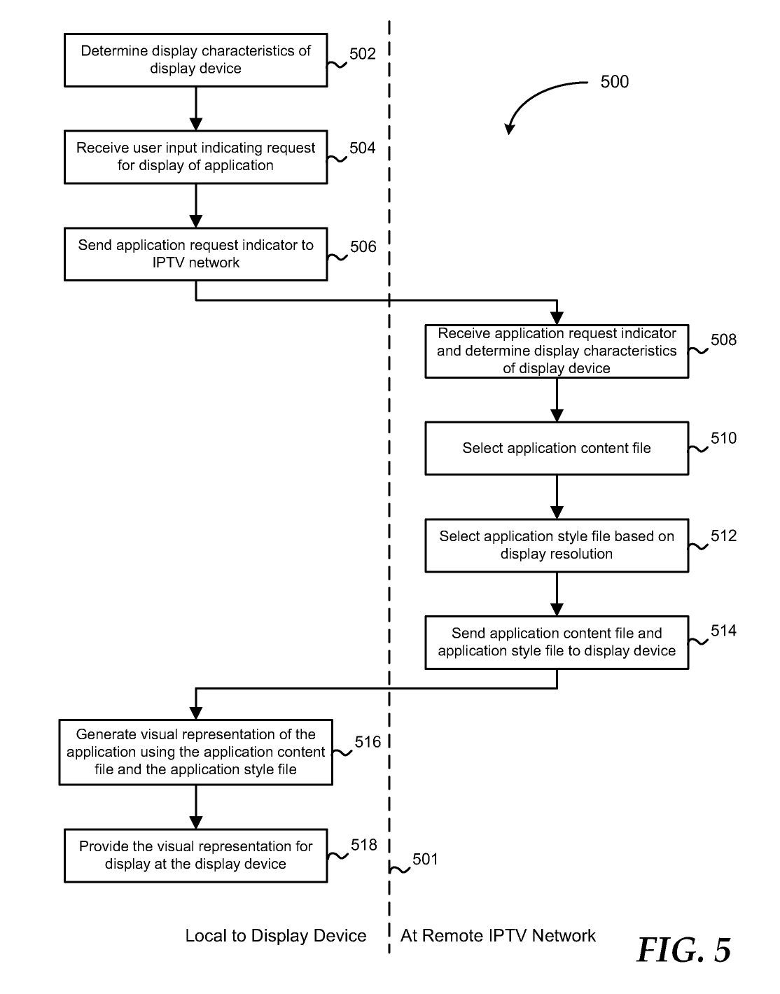

FIGS. 4 and 5 illustrate an alternate local application formatting system 400 and a method 500 of operation in accordance with at least one embodiment of the present disclosure. For ease of illustration, the local application formatting system 400 is described in the context of the IPTV system 100 of FIG. 1, whereby certain elements of the IPTV system 100 have been omitted for clarity purposes. As with the server-based implementation of FIG. 2, the local application formatting system 400 includes a local display system 402 connected to the client-facing tier 102 (FIG. 1) via, for example, the access network 166 (FIG. 1) and the client-facing tier 102 is connected to the application tier 104 (FIG. 1) via, for example, the private network 110 (FIG. 1). The application tier 104 includes the application server 142, the application content store 206 and the application style store 208.

The local display system 402 includes the display device 210 and a local display device interface 412. Like with local display device interface 212 of FIG. 2, the local display device interface 412 includes the network interface 220, the video interface 222, the remote interface 224, the central processing unit (CPU) 228, and a computer readable medium, such as the memory 230, a hard drive, flash memory, or a combination thereof. The computer readable medium stores a computer program 432 representing instructions executable by the CPU 228 or other component of the local display device interface 412 that manipulate the CPU 228 or other component to perform the functionality described herein. The local display device interface 412 further includes an application controller 426 having an interpreter 404. Thus, the implementation of FIG. 4 differs from the implementation of FIG. 2 in that rather than operating in a terminal services mode whereby the terminal server 134 utilizes an interpreter 204 to generate a visual representation of an application interface, the local display device interface 412 of FIG. 4 receives the application content file and the application style file for an application and interprets these files locally to generate a visual representation of the application interface locally. As with the interpreter 204, the interpreter 404 can include a markup language-based interpreter, such as the Microsoft™ Tasman web browser.

FIG. 5 illustrates a method 500 of an example operation of the local application formatting system 400 of FIG. 4 in accordance with at least one embodiment of the present disclosure. In the depicted example, processes represented by blocks to the left of dividing line 501 are performed at the local display system 402, whereas processes represented by blocks to the right of the dividing line 501 are performed remotely at one or more content servers (such as the client-facing tier 102 and the application tier 104 of the IPTV network 100).

At block 502 the local display device interface 412 determines one or more display characteristics of the display device 210. At block 504, the local display device interface 412 receives user input indicating the user has selected a particular application for display. In response to receiving the user input, the application controller 426 generates an application request indicator 240 and sends the application request indicator 240 to the client-facing tier 104 at block 506. At block 508, the client-facing tier 102 receives the application request indicator 240 and forwards it to the application server 142. Using the application request indicator 240, the application server 142 identifies the requested application and identifies the indicated display characteristic. At block 510, the application server 142 accesses the application content file 242 that corresponds to the identified application from the application content store 206. At block 312 the application server 142 accesses from the application style store 208 an application style file 244 selected from a plurality of application style files based on the identified display characteristic. The application server 142 then provides the application content file 242 and the application style file 244 to the client-facing tier 102, which forwards the application content file 242 and the application style file 244 to the local display device interface 412 at block 514. At block 516 the interpreter 404 at the local display device interface 412 uses the visual formatting information of the application style file 244 to format the content of the application content file 242 for the generation of a visual representation of the application. At block 518, the visual representation processed by the local display device interface 212 and provided for display at the display device 210.

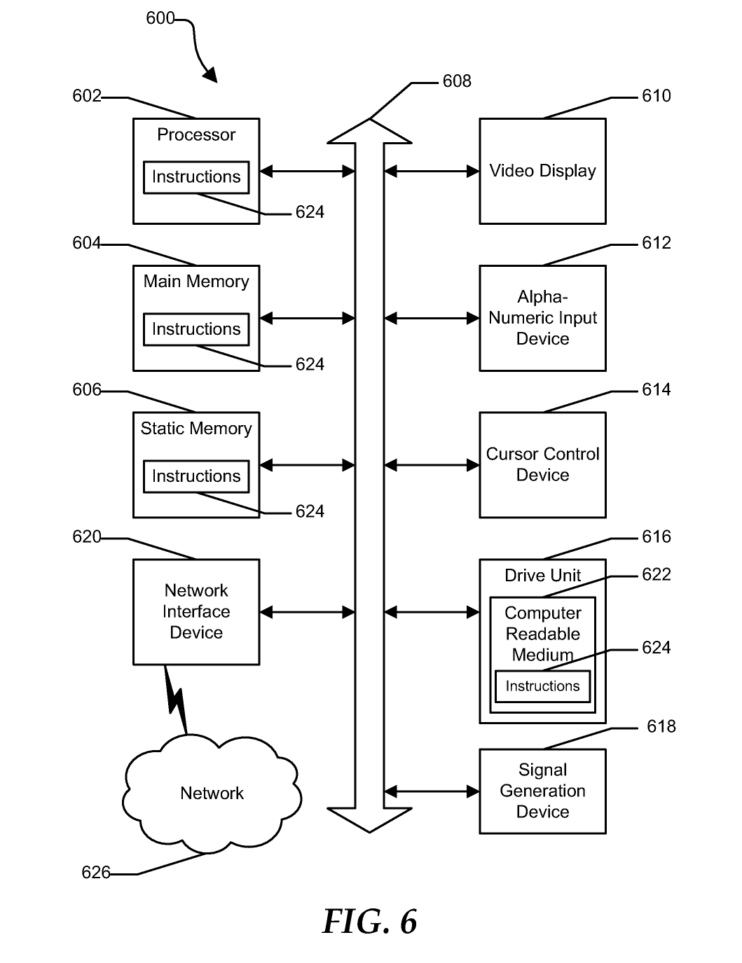

FIG. 6 shows an illustrative embodiment of a general computer system 600 in accordance with at least one embodiment of the present disclosure. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

What is claimed is:

1. A method comprising:
receiving a first indicator representative of a display characteristic of a display device and a second indicator representative of an application content file;
selecting an application style file from a plurality of application style files based on the first indicator;
generating a visual representation of an application using the application content file and the application style file, the visual representation being formatted for the display characteristic of the display device; and
providing the visual representation of the application for display at the display device.

2. The method of claim 1, wherein the first indicator comprises a uniform resource locator (URL) parameter.

3. The method of claim 2, wherein the second indicator comprises a URL address.

4. The method of claim 1, wherein the first indicator comprises a value in a header field of a network packet.

5. The method of claim 1, wherein the application content file is one selected from a group consisting of: a hypertext markup language (HTML) file; an extensible markup language (XML) file; an extensible hypertext markup language (XHTML) file; an active server pages (ASP) file; a java server pages (JSP) file; an image file; and a video file.

6. The method of claim 1, wherein:
the plurality of application style files comprises an application style file associated with a standard definition (SD) display resolution; an application style file associated with an SD-wide display resolution; and an application style file associated with a high-definition (HD) display resolution; and
the first indicator is representative of one of the SD resolution, the SD-wide resolution, and the HD resolution.

7. The method of claim 1, wherein:
receiving the first indicator and the second indicator comprises receiving the first indicator and the second indicator from the display device at a content server via a communications network;
selecting the application style file comprises selecting the application style file at the content server;
generating the visual representation comprises generating the visual representation at the content server; and
providing the visual representation comprises providing the visual representation from the content server to the display device via a communications network.

8. The method of claim 1, wherein:
receiving the first indicator and the second indicator comprises receiving the first indicator and the second indicator at a local interface for the display device;
selecting the application file comprises selecting the application style file at the content interface;
generating the visual representation comprises generating the visual representation at the content interface; and
providing the visual representation comprises providing the visual representation from the local interface to a display of the display device.

9. The method of claim 8, wherein the display device comprises a television and the content interface comprises a set-top box.

10. The method of claim 1, further comprising:
determining, at the display device, the first indicator representative of the display resolution of the display device;
receiving, at the display device, user input indicating a selection of the application;
determining, at the display device, the second indicator associated with the application; and
providing the first indicator and the second indicator from the display device in response to receiving the user input.

11. The method of claim 1, wherein the display device comprises one selected from a group consisting of: a television monitor; a computer monitor; and a communications-enabled portable device.

12. A method comprising:
receiving a uniform resource locator representative of an application to be displayed and a display characteristic of a display device via communications network;
generating, at a web browser application, a visual representation of the application using a hypertext markup language file associated with the application and a selected cascading style sheet associated with the display characteristic, the visual representation compatible with the display characteristic; and
providing the visual representation for display at the display device via the communications network.

13. An apparatus comprising:
an interface to receive a first indicator representative of a display resolution of a display device and a second indicator representative of an application content file;
an application content store configured to select the application content file from a plurality of application content files based on the second indicator;
an application style store configured to select an application style file from a plurality of application style files based on the first indicator;
an interpreter application configured to generate a visual representation of an application using the application content file and the application style file, the visual representation being formatted for the display resolution of the display device; and
an interface to provide the visual representation of the application for display at the display device.

14. The apparatus of claim 13, wherein the first indicator comprises a uniform resource locator (URL) parameter and the second indicator comprises a URL address.

15. The apparatus of claim 13, wherein the first indicator comprises a value in a header field of a network packet.

16. The apparatus of claim 13, wherein:
the plurality of application style files comprises an application style file associated with a standard definition (SD) display resolution; an application style file associated with a SD-wide display resolution; and an application style file associated with a high-definition (HD) display resolution; and
the first indicator is representative of one of the SD resolution, the SD-wide resolution, and the HD resolution.

17. The apparatus of claim 13, wherein:
the apparatus comprises a content server remotely coupleable to the display device via a communications network;
the first interface comprises an interface to the communications network; and
the second interface comprises an interface to the communications network.

18. The apparatus of claim 13, wherein:
the display device comprises one of a television or a monitor; and
the apparatus comprises a set-top box locally coupleable to the display device.

19. The apparatus of claim 13, wherein the apparatus comprises a component of the display device.

20. The apparatus of claim 19, wherein the display device comprises one selected from a group consisting of: a television monitor; a computer monitor; and a communications-enabled portable device.

21. A computer readable medium embodying a set of instructions, the set of instructions comprising:
instructions configured to manipulate a processor to receive a first indicator representative of a display characteristic of a display device and a second indicator representative of an application content file;
instructions configured to manipulate a processor to select an application style file from a plurality of application style files based on the first indicator;
instructions configured to manipulate a processor to generate a visual representation of an application using the application content file and the application style file, the visual representation being formatted for the display characteristic of the display device; and
instructions configured to manipulate a processor to provide the visual representation of the application for display at the display device.

22. The computer readable medium of claim 21, wherein the first indicator comprises a uniform resource locator (URL) parameter and the second indicator comprises a URL address.
